(19) United States
(12) Patent Application Publication
(10) Pub. No.: US 2025/0261620 A1
(43) Pub. Date: Aug. 21, 2025

(54) INSTALLATION AND METHOD FOR AUTOMATICALLY DETERMINING THE SEX OF A CHICK

(71) Applicant: EGG-CHICK AUTOMATED TECHNOLOGIES, PLOUEDERN (FR)

(72) Inventors: Damien Salaun, PLOUEDERN (FR); Romaric Chanu, PLOUEDERN (FR)

(21) Appl. No.: 19/042,799

(22) Filed: Jan. 31, 2025

(30) Foreign Application Priority Data
Feb. 20, 2024 (FR) 2401671

(51) Int. Cl. A01K 45/00; G06V 40/10

(52) U.S. Cl. CPC A01K 45/00; G06V 40/10

(57) ABSTRACT

The present invention relates to an installation and a method for automatically determining the sex of a chick, comprising
a belt conveyor comprising a conveyor belt (21) under tension for freely transporting said chick, said conveyor belt (21) defining a direction of travel,
a device for unbalancing the chick and causing it to voluntarily spread its wings,
at least one light source (25) to illuminate the chick's spread wings,
at least one imaging device (22, 23) to capture one or more images of the chick's wings thus illuminated,
a central unit configured to process the images acquired by the imaging device (22, 23) and determine from this configuration whether the chick is male or female, or whether the sex is undetermined.

According to the invention, the device for unbalancing the chick and causing it to voluntarily spread its wings comprises a rotating cam (19) placed under said conveyor belt (21), each cam being driven in rotation about an axle (20) placed transversely to said direction of travel, said cam being shaped to periodically come into contact with said conveyor belt (21) and thus raise a portion thereof upon such contact.

### TECHNICAL FIELD

The present invention relates to an installation and a method for automatically determining the sex of a chick.

### PRIOR ART

Sexing chicks is an important step in the poultry industry, enabling male chicks to be distinguished from females as soon as they hatch.

Such early differentiation of chicks is necessary to optimize their rearing by adapting management practices to each group of chicks of the same sex, helping to improve the efficiency and profitability of poultry farms.

It is well known that experienced operators are able to discern subtle details, enabling them to distinguish male from female chicks from the very first hours of life.

A common method for sexing chicks is to observe the wingtip feathers

of chicks, preferably less than a day old, or even two days old, for reliability reasons.

The sexing of chicks by their wings is in fact linked to a different arrangement of the feathers at the wing tips in females and males.

As shown in FIGS. 1 (female) and 2 (male), a chick's wingtips contain two rows of feathers, the primary flight feathers and the primary coverts.

Whereas in the male, the primary coverts are longer than, or substantially the same size as, the primary flight feathers, in the female, the tips of the primary coverts are always shorter than the tips of the primary flight feathers.

This method of determining the sex of a chick is relatively quick and non-invasive.

However, when it comes to differentiating several thousand chicks per hour, every day, with a small margin of error, as is practiced in intensive farming of laying hens, these operations can prove tedious for skilled operators.

Additionally, it is difficult to find enough workers specialized in this field today, which makes this necessary step relatively costly.

Methods for automatically sexing chicks are also known in the state of the art.

Patent FR 2 892 599 B1 in the name of the present applicant thus discloses an automatic chick sexing system using a camera to acquire images of the wingtips of a chick exposed to blue light and to identify, by analysis of these images, the characteristic feather arrangements of the male or female.

To ensure individual inspection of each chick, they are positioned in buckets arranged in a line, with their wings held apart by resting them on the rim of their respective bucket.

Although this automatic chick sexing method yields good results, as the wings are stable and therefore easily imaged, there is still room for improvement.

In fact, this machine is relatively cumbersome and complex to maintain.

Moreover, this machine does not allow for high processing speeds, which are now sought-after in intensive poultry farming.

Also known from patent application EP 1 092 347 A1 is a method for determining the sex of a chick wherein the chick is made to lose its balance in order to voluntarily spread its wings, then at least one wing thus spread is illuminated and said at least one wing thus spread is photographed with a view to determining the sex of this chick.

Chick imbalance can result from a variety of stimuli, such as prompting the chick to jump, shaking the chick or placing it proximate to a source of acoustic shock or heat, or moving it over a vibrating surface.

However, and according to the teaching of this document, once the chick's wings are spread, they physically interact with one or more supports to stabilize them in the spread position during tip illumination and image capture.

This physical interaction with rigid objects occurs while the chick is moving rapidly through the chick sexing device, increasing the risk of potentially fatal chick injury.

Additionally, it has been found that the method which involves vibrating a conveyor belt on which the chick is transported, in order to cause it to spread its wings, requires high vibration frequencies.

As a result, the animal is subjected not only to vibrations as it moves along the conveyor belt, but also to high levels of mechanical noise.

The animal's well-being is seriously affected as a result.

There is therefore a pressing requirement for an installation and a method for automatically determining the sex of a chick, the original design of which makes it possible to overcome the disadvantages of the prior art described above.

### SUBJECT MATTER OF THE INVENTION

The aim of the present invention is to overcome the disadvantages of the prior art by proposing an installation and a method for automatically determining the sex of a chick, which are simple in their design and in their operating mode, making it possible to ensure the well-being of the animal and to preserve its health.

Another object of the present invention is such an installation and such a method for automatic determination of the sex of a chick allowing extremely fast processing rates, and by way of illustration, of more than 70,000 chicks per hour.

A further object of the present invention is such an installation and method for automatically determining the sex of a chick, guaranteeing the highest resolution rate in chick sex determination and increased reliability.

### DISCLOSURE OF THE INVENTION

To this end, the invention relates to an installation for automatically determining the sex of a chick, comprising:
a belt conveyor comprising a preferably flexible conveyor belt under tension for freely transporting said chick, said conveyor belt defining a direction of travel,
a device for unbalancing the chick and causing it to voluntarily spread its wings as it moves along at least part of said belt conveyor,
at least one light source to illuminate the chick's spread wings,
at least one imaging device for capturing one or more images of the chick's wings thus illuminated,
a central unit configured to process the images acquired by said at least one imaging device in order to isolate, on at least some of these images, the tip of at least one of the wings of said chick, analyze the configuration of the feathers at said at least one tip, and determine from this configuration whether it is a male or female chick, or whether the sex is undetermined.
   According to the invention, said device for unbalancing the chick and causing it to voluntarily spread its wings comprises at least one rotating cam placed under said conveyor belt, each cam being driven in rotation about an axle placed transversely, or substantially transversely, to said direction of travel, said cam being shaped to periodically come into contact with said conveyor belt and thus raise a portion thereof upon such contact.

Advantageously, the original design of this installation for automatically determining the sex of a chick guarantees free movement of the chick, in a less noisy and less stressful environment, which contributes to the chick's well-being.

This installation advantageously allows high automatic processing rates typically greater than 70,000 eggs per hour, or even greater than 90,000 eggs per hour.

The expression “free transport of said chick” means that the chick is transported without constraint, being carried solely by the conveyor belt as it moves along the conveyor. Thus, when the chick is balanced, it is generally in contact only with this belt, via its legs.

Similarly, when the chick spreads its wings under the effect of a stimulus causing it to become unbalanced, no external supports, such as ramps placed laterally to the conveyor belt, are provided for these spread wings to rest on.

Each rotating cam thus enables a part of the conveyor belt to be raised temporarily, or even momentarily, when brought into contact with it, to form an elevation, advantageously localized, of this conveyor belt, such as a bump or, depending on the number and respective positioning of at least two cams, a platform raised relative to the rest of the outer surface of the conveyor belt. The configuration of the rest of the conveyor belt surface at a distance from said at least one rotating cam remains unchanged.

Of course, depending on the spacing between two adjacent rotating cams, the surface of the conveyor belt placed between two areas of this belt in direct contact with these rotating cams may itself be raised.

Advantageously, the inventors have found that the formation or disappearance of this or these temporary elevation or elevations helped to unbalance the chick, causing it to spread its wings. This objective is achieved while guaranteeing stress-free transport for the animal and no danger to its health.

The stimulus causing the chick's wings to open thus results from an imbalance in the chick caused by a localized change in the conveyor belt's configuration, and in particular by the generation of an elevation such as a bump or a raised platform, or by the disappearance of this elevation.

Preferably, the height of this elevation is between 10 mm and 35 mm, preferably between 15 mm and 30 mm, and even more preferentially between 17 mm and 25 mm in relation to the rest of the conveyor belt's outer surface.

By adjusting the number of cams used and their frequency of rotation, the maintenance of the chick's spread wings is observed over a period of time sufficient to illuminate and capture a plurality of images thereof.

According to an embodiment of this installation for automatically determining the sex of a chick, each cam comprises at least one active profile area, said active profile areas coming into contact with said conveyor belt one after the other during the rotation of the corresponding cam when there are several of them, said active profile area(s) of said cam being shaped to ensure that the latter remains out of contact with this conveyor belt during at least part of its rotation.

Advantageously, each active profile area can also be equipped with ball bearings to reduce friction with said rotating conveyor belt.

In another embodiment of this installation for automatically determining the sex of a chick, each cam has at least one rounded active profile area, such as a semi-cylindrical one.

Preferably, the cam(s) are shaped to raise the conveyor belt portion by a height of between 17 mm and 25 mm.
The cam may also comprise two active profile areas, alternately coming into contact with said conveyor belt. For example, the cam may comprise a body enclosing the axle and bearings, and a cage, the cage comprising a front branch and a rear branch connected to the body by arms, each of these branches having a rounded profile.

According to yet another embodiment of this installation for automatically determining the sex of a chick, it comprises two rotating cams, placed under said conveyor belt and spaced apart from one another along the direction of travel defined by said conveyor, each of these cams being driven in rotation about an axle placed transversely, or substantially transversely, with respect to said direction of travel, each cam being shaped to periodically come into contact with said conveyor belt and thus raise a portion thereof upon this contact so as to cause said chick to voluntarily spread its wings when the latter is in said conveyor belt portion thus raised.

According to yet another embodiment of this installation for automatically determining the sex of a chick, said cams placed under the same conveyor belt being identical, said installation is configured to operate them synchronously in order to raise a part of the conveyor belt at the same time, or even simultaneously.

Alternatively, said installation can be configured to operate these identical rotating cams asynchronously, under the same conveyor belt.

According to yet another embodiment of this installation for automatically determining the sex of a chick, said cams, placed under the same conveyor belt, are different, said installation being configured to operate them synchronously.

Alternatively, said installation can be configured to operate these rotating cams asynchronously.

In yet another embodiment of this installation for automatically determining the sex of a chick, the frame of said belt conveyor is configured so that said conveyor belt is trough-shaped to automatically center said chick as it is transported.

Thus, when the portion of the conveyor belt descends again after being raised by the cam(s), this portion resumes its trough shape, thus re-centering the chick on the conveyor belt and preventing it from physically interacting with the conveyor edges.

According to yet another embodiment of this installation for automatically determining the sex of a chick, said first cam and said second cam are spaced apart and shaped to move the portion of the conveyor belt placed between said cams between a free, or non-contacting, trough-shaped configuration and a raised flat, or substantially flat, configuration so that said chick at least partially follows a rectilinear or substantially rectilinear trajectory. These rotating cams can thus be arranged so that the flexible conveyor belt is tensioned between them.

Advantageously, it has been observed that such a configuration of the part of the conveyor belt placed between the cams guarantees optimum acquisition of images of the chick, in particular of its wing tips, the chick then moving substantially horizontally, that is, at a constant, or substantially constant, elevation under the camera(s). The images captured are perfectly sharp.

According to yet another embodiment of this installation for automatically determining the sex of a chick, each cam is configured to raise a portion of said conveyor belt as it rotates, and transmit an impulse to said chick placed on said conveyor belt portion so as to propel the latter into the air above said conveyor belt.

In an advantageous embodiment, the chick can be made to take off as little as possible when the cam(s) raise(s) the conveyor belt, or even simply cushion the change in conveyor belt configuration with its legs.
In a particularly advantageous embodiment, the chick can be lifted above the outer surface of the conveyor belt.
Said rotating cams of the installation are then configured to cause the chick to be lifted above the part of the conveyor belt thus raised.
By “lifting”, we mean that the chick adapts to the variation in height of the conveyor belt thus raised by compensating with its legs and opening its wings to seek balance in this constant imbalance. This gives the impression of advancing on the conveyor at a substantially constant height, which remains higher than the lowest level of the conveyor belt thus raised.

In yet another example of this installation for automatically determining the sex of a chick, said conveyor is horizontal.

According to yet another embodiment of this installation for automatically determining the sex of a chick, said or at least one of the light sources is configured to emit blue light.

Advantageously, said or at least one of the light sources is configured to emit violet light at a wavelength between 380 nm and 420 nm, and even better, violet light at a wavelength centered on 405 nm.

According to yet another embodiment of this installation for automatically determining the sex of a chick, each imaging device is a matrix camera for detecting at least the visible light reflected by said chick when it is illuminated by said at least one light source.

Preferably, said conveyor comprising two rotating cams and two matrix cameras spaced along said conveyor, the field of view of a first of said cameras covers a first area of the conveyor belt, at least a majority of which is located downstream of the first rotating cam, the “downstream” position being considered with respect to the direction of transport of the chick along said conveyor, and the field of view of a second camera covers a second area of the conveyor belt overlapping or not overlapping part of said first conveyor belt area, a portion of said second area of the conveyor belt thus imaged being positioned downstream of the second rotating cam.

This makes it possible to track each chick individually until it leaves the conveyor, thus ensuring that each chick is processed appropriately.
In this way, at least the first camera covers a majority of the part of the conveyor belt located between the portions of the conveyor belt in contact with the rotating cams.

According to yet another embodiment of this installation for automatically determining the sex of a chick, said conveyor comprises, in its exit area, a chick ejection device configured to send the latter to a first processing conveyor or to a second processing conveyor distinct from the first, depending on the sex of the chick identified during processing of said images.

Preferably, the field of view of the second camera also covers said exit area of said conveyor to ensure individual tracking of the chick at least until it arrives at, or passes through, the ejection device.

According to yet another embodiment of this installation for automatically determining the sex of a chick, it comprises at least two belt conveyors arranged parallel to one another for processing several chicks at a time, each conveyor being equipped with one or more rotating cams placed under the conveyor belt of the corresponding conveyor, each cam being driven in rotation about an axle positioned transversely, or substantially transversely, to the direction of travel defined by the corresponding conveyor, each cam being shaped to periodically come into contact with the conveyor belt of the corresponding conveyor and thus raise a portion thereof upon such contact.

According to yet another embodiment of this installation for automatically determining the sex of a chick, it comprises n rectilinear belt conveyors arranged in series, n being greater than or equal to 2, the outlet of each conveyor thus opening onto the inlet of the immediately following conveyor, all of these conveyors defining a transport path, each conveyor comprising one or more rotating cams placed under the conveyor belt of the corresponding conveyor, each cam being driven in rotation about an axle placed transversely, or substantially transversely, to the direction of travel defined by the corresponding conveyor, each cam being shaped to periodically contact the conveyor belt of the corresponding conveyor and thereby raise a portion thereof upon such contact, only the conveyor positioned furthest downstream comprising said at least one imaging device and said at least one light source, said conveyor(s) positioned upstream thereof enabling said chick to be prepared for sex determination on the conveyor positioned furthest downstream.

It is advantageous to note that such a training phase for the chick by its passage on one or more so-called training conveyors ensures a spontaneous reaction of the chick, and therefore a faster spreading of its wings, on the conveyor placed furthest downstream at the critical moment of the illumination and image capture operations to determine its sex.

The present invention also relates to a method for the automatic determination of the sex of a chick wherein the following steps are carried out:
moving a chick on a belt conveyor comprising a conveyor belt under tension, said conveyor defining a direction of movement of the chick,
momentarily raising at least a portion of this conveyor belt whereupon the chick is transported freely to generate at least one elevation of this conveyor belt such as a bump or a platform raised with respect to the rest of the conveyor belt, in order to unbalance said chick and cause the voluntary spreading of its wings, this elevation comprising at least the portion of the belt with which said chick is directly in contact,
illuminating at least one wing thus spread of said chick, and
detecting at least part of the light reflected by said at least one wing thus illuminated,
processing the images thus acquired in order to isolate, on at least some of these images, the tip of at least one of the wings of said chick, analyzing the configuration of the feathers at said at least one tip and determining, from this configuration, whether it is a male or female chick or whether the sex is undetermined.

Preferably, this conveyor belt is flexible.

According to one embodiment of this method of automatically determining the sex of a chick, said at least one conveyor belt portion is raised by one or more rotating cams placed under said conveyor belt, each cam being driven in rotation about an axle placed transversely, or substantially transversely, to said direction of travel, each cam being shaped to periodically come into contact with said conveyor belt and thus raise a portion thereof upon such contact

According to another embodiment of this method of automatically determining the sex of a chick, said at least one conveyor belt portion is raised by two rotating cams placed under said conveyor belt, the operations of the first cam and the second cam are synchronized.

Alternatively, said at least one conveyor belt portion is raised by two rotating cams placed under said conveyor belt, the operations of the first cam and the second cam are asynchronous.

The cams may or may not be identical.

In yet another embodiment of this method of automatically determining the sex of a chick, the belt conveyor frame being configured so that said conveyor belt is trough-shaped in order to automatically center said chick as it is transported, a portion of said conveyor belt is raised from a first, trough-shaped, free configuration to a second, flat or substantially flat configuration, wherein said conveyor belt portion is flat or substantially flat.

According to yet another embodiment of this method for automatically determining the sex of a chick, the or each part of the conveyor belt thus raised has an elevation of between 8 mm and 16 mm in relation to the rest of the outer surface of said conveyor belt.

Another method for automatically determining the sex of a chick involves adjusting the frequency of rotation of the rotating cam(s) located under the conveyor belt of a rectilinear belt conveyor, for a given speed of travel of this conveyor belt, in order to obtain maximum spontaneous unfolding of the chick's wings.

### BRIEF DESCRIPTION OF THE DRAWINGS

Other advantages, aims and particular features of the present invention will become apparent from the following description, made, for explanatory purposes and in no way limiting, with reference to the appended drawings, in which:

FIG. 1 shows views of the wing tip of a female chick;

FIG. 2 shows views of the wing tip of a male chick;

FIG. 3 is a partial schematic depiction of an installation for automatically determining the sex of a chick according to a particular embodiment of the present invention;

FIG. 4 is another partial view of the installation for automatically determining the sex of a chick shown in FIG. 3, with the conveyor belt partially shown to highlight the rotating cams;

FIG. 5 is a partial cross-sectional view of only the conveyors of the installation for determining the sex of a chick shown in FIG. 3;

FIG. 6 is a partial top view of the installation for automatically determining the sex of a chick shown in FIG. 3, showing the exit area of this installation, with the conveyor belt partially shown to highlight the rotating cams;

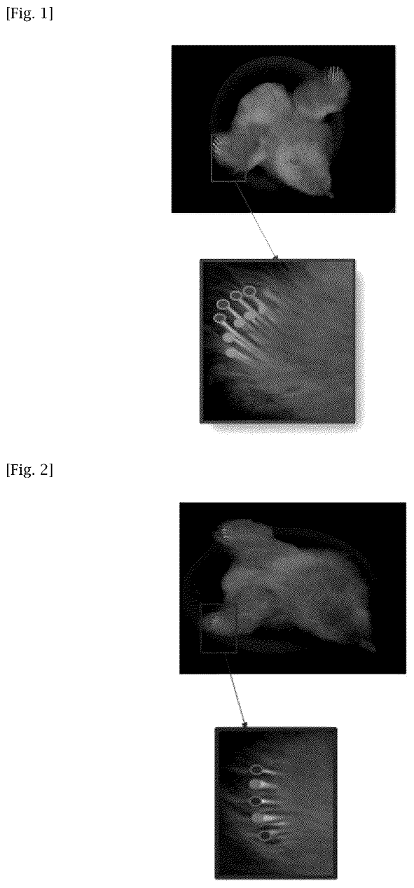

### DESCRIPTION OF EMBODIMENTS

The drawings and the following description essentially contain elements of a certain nature. They may therefore not only serve to better understand the present invention, but also contribute to its definition, where appropriate.

First, it should be noted that the figures are not to scale.

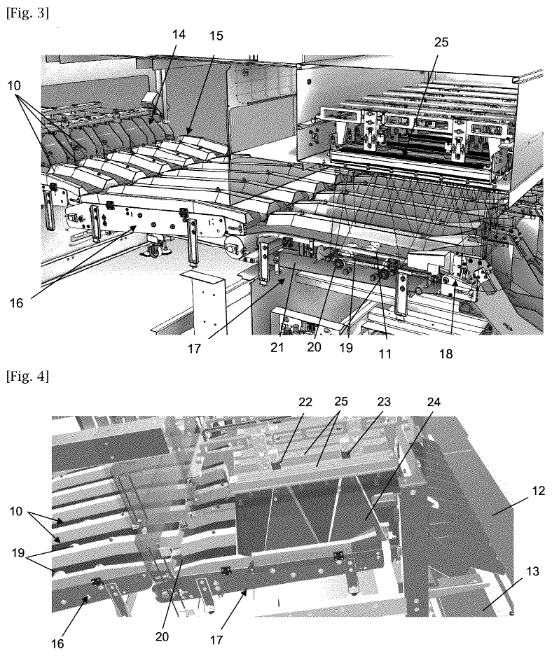

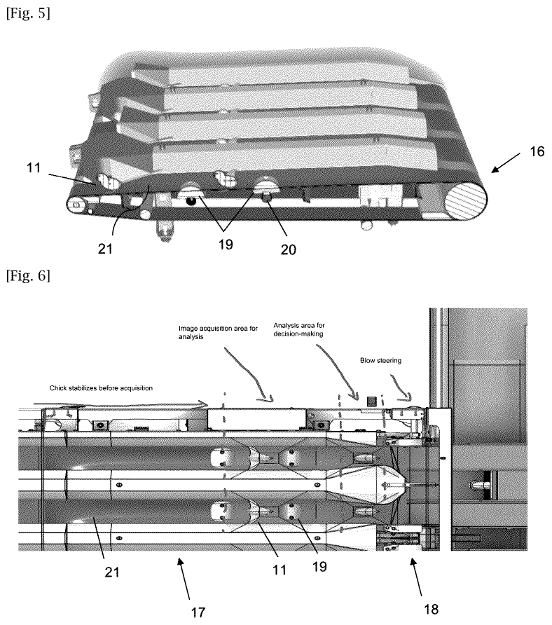

FIGS. 3 to 6 schematically and partially show an installation for automatically determining the sex of a chick according to a particular embodiment of the present invention.

This installation comprises several identical processing lines 10 arranged in parallel to determine the sex of a plurality of chicks at the same time. There is no limit to the number of these processing lines 10.

Moreover, each processing line 10 of this installation comprises several rectilinear conveyors arranged in series, which thus define a direction of movement, or transport axis, of the chicks 11 up to evacuation conveyors 12, 13, each intended to transport chicks of the same sex, after differentiation and separation of the latter according to their sex.

On each processing line 10, a first conveyor 14, positioned upstream of the line, is configured to enable chicks deposited in bulk at the entrance to this first conveyor 14 to be organized and placed in single file.

The outlet of this first conveyor 14 opens onto a second conveyor 15, known as the separation conveyor, whose conveying speed is higher than the conveying speed of the first conveyor 14 to ensure spatial separation of the chicks.

The outlet of this second conveyor 15 opens onto the inlet of a third rectilinear conveyor 16, known as the “chick training” conveyor. A single training conveyor is shown here, but the installation could include one or more other so-called chick training conveyors 16 to enhance training of the latter.

The outlet of this third conveyor 16 opens onto the inlet of a fourth conveyor 17, known as the “chick gender identification” conveyor. This fourth belt conveyor 17 is configured to enable the actual capture of one or more images of at least one spread wing of each chick transported by this conveyor.

The outlet of this fourth conveyor 17 leads to a station 18 for sorting the chicks according to their sex, previously identified by capturing images and processing these images with an appropriate algorithm, with a view to evacuating them to processing stations adapted to the sex of the chick 11.

Each of these belt conveyors comprises a flexible conveyor belt under tension. These belt conveyors are horizontal.

The frames of the second, third and fourth belt conveyors 15-17 are configured so that their conveyor belts are trough-shaped to automatically center a chick during transport. The chick 11 is free and only carried by its legs when it is balanced on the corresponding conveyor belt.

The third and fourth conveyors 16, 17 also each comprise two rotating cams 19, placed under their conveyor belt 20, at a distance from one another. These rotating cams 19 are driven in rotation about an axle 20 positioned perpendicular to the direction of travel.

These rotating cams 19 are also identical and synchronized on each conveyor 16, 17. Each rotating cam 19 thus includes a half-cylindrical active profile area, with the rounded part facing outwards. The configuration of the cam's active profile area ensures periodic contact, in this case with each revolution, with the conveyor belt 21 of the corresponding conveyor 16, 17.

Bringing the active profile area of each rotating cam 19 into contact in this way makes it possible to temporarily raise a portion of this conveyor belt 21 so as to cause the chick 11 to voluntarily spread its wings, when the latter is on said portion of the conveyor belt which is thus raised.

A portion of the conveyor belt 21 is temporarily raised, but only for the time during which the active profile area of the rotating cam 19 is in contact with the conveyor belt 21.

When the active profile area moves away from the conveyor belt 21, due to the rotation of the corresponding cam 19, the conveyor belt is no longer in contact with the rotating cam and therefore returns to its initial, trough-shaped configuration.

On each of the third and fourth conveyors 16, 17, the two rotating cams 19 are arranged to raise a portion of the conveyor belt 21, this raising having a straight longitudinal section of substantially trapezoidal shape (ascent, plateau, descent). In this case, the elevation of part of the conveyor belt is between 17 and 25 mm.

The aim of the third rectilinear conveyor 16 is to train the chick to spread its wings more efficiently and impulsively when it encounters the same elevation on the fourth rectilinear conveyor 17.

Advantageously, this ensures that the wings of the chick 11 are spontaneously spread when the lighting and image capture operations are carried out to determine its sex.

This installation includes light sources 25 placed on both sides of and above the conveyor belt to illuminate the spread wings of the chick. These light sources 25 are configured to emit violet light at a wavelength between 380 nm and 420 nm, and even better, violet light at a wavelength centered on 405 nm.

This installation also includes two matrix cameras 22, 23 positioned above a downstream part of this fourth conveyor 17 and spaced apart from one another along this conveyor.

These matrix cameras 22, 23 are arranged so that the field of view of a first 22 of these cameras covers a first area of the conveyor belt 21, at least a majority of which is located downstream of the first rotating cam 19, while the field of view of the other matrix camera 23 covers a second area of the conveyor belt 21 located downstream of this first area.

More precisely, this second area of the conveyor belt 21 thus covered by the field of view 24 of the second matrix camera 23 comprises both an end of this first conveyor belt area imaged by the first matrix camera 22 and an area of the conveyor belt placed downstream of the second rotating cam 19 so that there is an overlap between these two imaged areas of the conveyor belt 21.

In addition, the field of view of the second matrix camera 23 covers the exit area of the fourth rectilinear conveyor 17.

In this way, each chick 11 can be tracked individually from the moment it enters the elevated conveyor section until it exits the fourth rectilinear conveyor 17.

In the exit area of the fourth rectilinear conveyor 17, an ejection device 18 is positioned, configured to send the exiting chick 11 to a first processing conveyor 12 or to a second processing conveyor 13 separate from the first, depending on the sex of the chick identified after processing the images acquired by the matrix cameras 22, 23.

This ejection device here comprises one or more blowguns (not shown), or devices for producing a jet of pressurized air, to direct, or steer, a chick 11 toward a pre-established exit path depending on its sex.

Of course, the distance separating the second rotating cam 19 from this ejection device 18 is determined so that the algorithm processing the captured images of the chick's wings has enough time to identify the sex of this chick 11.

Tests have been carried out with the above-described installation to demonstrate its effectiveness in determining the sex of a chick 11.

According to a first embodiment, the rotating cams 19 placed under the conveyor belt 21 of a rectilinear “image acquisition” conveyor are configured to raise a portion of the corresponding conveyor belt by a maximum height of 33 mm relative to the rest of the outer surface of this conveyor belt.

The rotational speed (revolutions per minute=rpm) of these rotating cams 19 is set at 1800 rpm.

Each of these rotating cams 19 has a single active profile area with a semi-cylindrical shape.

The advantage of this embodiment is that the average error rate for identifying the chick's sex is very low.

According to another embodiment, the pair of rotating cams 19 placed under the conveyor belt of a first rectilinear belt conveyor called “chick training” conveyor and the pair of rotating cams 19 placed under the conveyor belt 21 of a second rectilinear belt conveyor called “image acquisition” conveyor are identical and configured so that a first of the rotating cams of each pair, placed upstream of the corresponding conveyor, is configured to raise a portion of the corresponding conveyor belt by a height of about 25 mm relative to the rest of the outer surface of this conveyor belt, while the other cam of the pair, placed downstream, is configured to raise a portion of the corresponding conveyor belt by a height of about 33 mm.

In addition, the rotational speed (revolutions per minute=rpm) of the rotating cams 19 of the “chick training” conveyor is set at 1500 rpm, while the rotational speed of the rotating cams 19 of the second “image acquisition” conveyor is set at 2400 rpm.

In this embodiment as well, the average error rate for identifying the chick's sex is very low.

According to yet another embodiment of the invention, the pair of rotating cams 19 placed under the conveyor belt of a first rectilinear belt conveyor called “chick training” conveyor and the pair of rotating cams 19 placed under the conveyor belt 21 of a second rectilinear belt conveyor called “image acquisition” conveyor are identical and configured so that a first of the cams of each pair, positioned upstream of the corresponding conveyor, is configured to raise a portion of the corresponding conveyor belt by a height of about 25 mm relative to the rest of the outer surface of this conveyor belt, while the other cam of the pair, positioned downstream, is configured to raise a portion of the corresponding conveyor belt by a height of about 17 mm.

In addition, the rotational speed (revolutions per minute=rpm) of the rotating cams 19 of the first conveyor is set at 1800 rpm, while the rotational speed of the rotating cams 19 of the second conveyor is set at 3000 rpm.

Once again, in this embodiment the average error rate for identifying the chick's sex is very low.

It should be noted that the frequency of the rotating cams 19 on the second rectilinear conveyor, known as the image acquisition conveyor, or the image capture conveyor for capturing images of the spread wings, is always higher than the frequency of the rotating cams on the first conveyor, known as the “training” conveyor, as it is desired to cause the greatest imbalance in the area where one or more images of the chick's spread wings are captured.

1. An installation for automatically determining the sex of a chick, comprising
a belt conveyor comprising a conveyor belt under tension for freely transporting said chick, said conveyor belt defining a direction of travel,
a device for unbalancing the chick and causing it to voluntarily spread its wings as it moves along at least part of said belt conveyor,
at least one light source to illuminate the chick's spread wings,
at least one imaging device for capturing one or more images of the chick's wings thus illuminated,
a central unit configured to process the images acquired by said at least one imaging device in order to isolate, on at least some of these images, the tip of at least one of the wings of said chick, analyze the configuration of the feathers at said at least one tip, and determine from this configuration whether it is a male or female chick, or whether the sex is undetermined,
wherein said device for unbalancing the chick and causing it to voluntarily spread its wings comprises at least one rotating cam placed under said conveyor belt, each cam being driven in rotation about an axle placed transversely, or substantially transversely, to said direction of travel, said cam being shaped to periodically come into contact with said conveyor belt and thus raise a portion thereof upon such contact.

2. The installation according to claim 1, wherein each rotating cam comprises at least one active profile area, said active profile areas coming into contact with said conveyor belt one after the other during the rotation of the corresponding cam, said active profile areas of said cam being shaped to ensure that the latter remains out of contact with this conveyor belt during at least part of its rotation.

3. The installation according to claim 1, wherein each rotating cam has at least one rounded active profile area.

4. The installation according to claim 1, further comprising two rotating cams, placed under said conveyor belt and spaced apart from one another along the direction of travel defined by said conveyor, each of these cams being driven in rotation about an axle placed transversely, or substantially transversely, with respect to said direction of travel, each cam being shaped to periodically come into contact with said conveyor belt and thus raise a portion thereof upon this contact so as to cause said chick to voluntarily spread its wings when the latter is in said conveyor belt portion thus raised.

5. The installation according to claim 4, wherein said rotating cams being identical, said installation is configured to operate them synchronously or asynchronously.

6. The installation according to claim 1, wherein the frame of said belt conveyor is configured so that said conveyor belt is trough-shaped to automatically center said chick as it is transported.

7. The installation according to claim 4, wherein said rotating cams are spaced apart and shaped to move the portion of the conveyor belt placed between said rotating cams between a free, or non-contacting, trough-shaped configuration and a raised flat, or substantially flat, configuration so that said chick at least partially follows a rectilinear or substantially rectilinear trajectory.

8. The installation according to claim 1, wherein each rotating cam is configured to raise a portion of said conveyor belt as it rotates, and transmit an impulse to said chick placed on said conveyor belt portion so as to propel the latter into the air above said conveyor belt.

9. The installation according to claim 8, wherein said conveyor comprises two rotating cams and at least two matrix cameras, spaced along said conveyor, the field of view of a first of said cameras covers a first area of the conveyor belt, at least a majority of which is located downstream of the first rotating cam, and the field of view of a second camera covers a second area of the conveyor belt, which may or may not overlap part of said first conveyor belt area, a portion of said second conveyor belt area thus imaged being located downstream of the second rotating cam.

10. The installation according to claim 9, wherein said conveyor comprises, in its exit area, a chick ejection device configured to send the latter to a first processing conveyor or to a second processing conveyor distinct from the first, depending on the sex of the chick identified during processing of said images.

11. The installation according to claim 10, wherein the field of view of the second camera also covers said exit area of said conveyor to ensure individual tracking of the chick at least until it arrives at, or passes through, the ejection device 18.

12. The installation according to claim 1, further comprising at least two belt conveyors arranged parallel to one another for processing several chicks at a time, each conveyor being equipped with one or more rotating cams placed under the conveyor belt of the corresponding conveyor, each cam being driven in rotation about an axle positioned transversely, or substantially transversely, to the direction of travel defined by the corresponding conveyor, each cam being shaped to periodically come into contact with the conveyor belt of the corresponding conveyor and thus raise a portion thereof upon such contact.

13. The installation according to claim 1, further comprising characterized in that it comprises-n rectilinear belt conveyors arranged in series, n being greater than or equal to 2, the outlet of each conveyor opening onto the inlet of the immediately following conveyor, all of these conveyors defining a transport path, each conveyor comprising one or more rotating cams placed under the conveyor belt of the corresponding conveyor, each cam being driven in rotation about an axle placed transversely, or substantially transversely, to the direction of travel, each rotating cam being shaped to periodically contact the conveyor belt of the corresponding conveyor and thereby raise a portion of this conveyor belt upon such contact, only the conveyor positioned furthest downstream comprising said at least one imaging device and said at least one light source, said belt conveyors positioned upstream thereof enabling said chick to be prepared for sex determination on the rectilinear conveyor positioned furthest downstream.

14. A method for automatically determining the sex of a chick, wherein the following steps are carried out:
moving a chick on a belt conveyor comprising a conveyor belt under tension, said conveyor defining a direction of movement of the chick,
momentarily raising at least a portion of this conveyor belt whereupon the chick is transported freely to generate at least one elevation of this conveyor belt such as a bump or a platform raised with respect to the rest of the conveyor belt, in order to unbalance said chick and cause the voluntary spreading of its wings, this elevation comprising at least the portion of the belt with which said chick is directly in contact,
illuminating at least one wing thus spread of said chick,
detecting the light reflected by said at least one wing thus illuminated,
processing the images thus acquired in order to isolate, on at least some of these images, the tip of at least one of the wings of said chick,
analyzing the configuration of the feathers at said at least one tip, and
determining, from this configuration, whether it is a male or female chick or whether the sex is undetermined.

15. The method according to claim 14, wherein said at least one conveyor belt portion is raised by one or more rotating cams placed under said conveyor belt, each cam being driven in rotation about an axle placed transversely, or substantially transversely, to said direction of travel, each cam being shaped to periodically come into contact with said conveyor belt and thus raise a portion thereof upon such contact.

16. The method according to claim 15, wherein said at least one conveyor belt portion being raised by two rotating cams placed under said conveyor belt, the operations of rotating cams are asynchronous.

17. The method according to claim 14, wherein the belt conveyor frame is configured so that said conveyor belt is trough-shaped in order to automatically center said chick as it is transported, a portion of said conveyor belt is raised from a first, trough-shaped, free configuration to a second, flat or substantially flat configuration, wherein said conveyor belt portion is flat or substantially flat
